(19) United States
(12) Patent Application Publication
(10) Pub. No.: US 2026/0087459 A1
(43) Pub. Date: Mar. 26, 2026

(54) MEDIA INTRODUCTION AND CURATED INFORMATION DELIVERY SYSTEM AND METHOD THEREOF

(71) Applicant: Michaelangelo Casanova, New Britain, CT (US)

(72) Inventor: Michaelangelo Casanova, New Britain, CT (US)

(21) Appl. No.: 19/330,942

(22) Filed: Sep. 17, 2025

Related U.S. Application Data
(60) Provisional application No. 63/697,472, filed on Sep. 21, 2024.

(51) Int. Cl. G06Q 10/109

(52) U.S. Cl. CPC G06Q 10/109

(57) ABSTRACT

A media introduction and curated information delivery system is disclosed. The media introduction and curated information delivery comprises at least one processor configured to detect, via a trigger event detection module, a scan of a machine-readable code in real time; initiate, via a media sequencing engine communicatively, automatically a first dynamic media presentation for a first user, in response to detecting the scan of the machine-readable code; transit, from the first dynamic media presentation to a second dynamic media presentation; retrieve, via an information curation module, factual data associated with the first user; filter, automatically non-essential information from the factual data, based at least on predefined relevance criteria; synchronize the filtered factual data as a guided information panel with the second dynamic media presentation; and display, via a scrolling navigation interface module, the filtered factual data synchronized with the second dynamic media presentation to a second user.

### CROSS-REFERENCE TO RELATED APPLICATION

This application claims the priority benefit of provisional patent application Ser. No. 63/697,472, filed Sep. 21, 2024 by the present inventor, which is incorporated herein by reference in its entirety.

### FIELD OF THE DISCLOSURE

The present invention relates in general to an information presenting and presentation systems, and particularly to a media introduction and curated information delivery system and method thereof.

### BACKGROUND OF THE DISCLOSURE

Traditional approaches for exchanging personal or business information often rely on paper business cards or static digital equivalents. The paper business cards are inherently limited in capacity, offering only a few lines of contact details and, once distributed, cannot be updated or personalized. The paper business cards are frequently discarded shortly after exchange, resulting in a lost opportunity for sustained engagement. While certain digital formats have emerged to address the shortcomings of paper, these digital formats implementations typically provide only basic text or hyperlinks, and fail to leverage the growing demand for interactive and media-rich introductions that leave a lasting impression on recipients.

More recent digital business card platforms attempt to overcome the limitations of physical cards by adopting website-style navigation structures. However, the website-style navigation structures often overwhelm recipients with excessive or poorly organized information. Viewers may be presented with multiple tabs, nested menus, or redundant content, leading to longer decision-making times and reduced effectiveness of the intended message. Moreover, such platforms typically lack mechanisms for integrating analytics, measuring engagement, or triggering immediate calls-to-action, thereby limiting digital business card platform's usefulness as a tool for meaningful brand or individual introduction.

Numerous solutions have been presented in the prior art to facilitate digital information exchange and electronic business card systems, such as those shown in US20070129959A1 to Joseph, US20160124469A1 to Kareem, and US20050278260A1 to Paul. While each of these references addresses certain aspects of digital introductions or information sharing, they typically focus on static presentation of data or navigation-driven interfaces that mimic websites. Such approaches often lack sequential media storytelling, real-time customization, or curated factual content synchronized with dynamic presentations. Accordingly, they present limitations in engagement, interactivity, and personalization when compared to the needs of modern business communication.

Particularly, '959 to Joseph discloses a system for providing personal contact information through electronic means, including integration with mobile devices. While this system improves portability over traditional paper business cards, the disclosed approach primarily replicates static contact details in digital form. It does not provide for rich media introductions, sequential brand and individual presentation, or automated filtering of relevant factual content. As a result, the system offers limited emotional engagement and lacks mechanisms for guiding recipients toward immediate interaction or calls-to-action.

Particularly '469 to Kareem describes methods and systems for creating and sharing digital business cards that can include multimedia content and links. Although this reference allows inclusion of enhanced information compared to static text, it relies heavily on website-style navigation and manual selection by the viewer. Such an arrangement risks overwhelming recipients with extraneous content, thereby extending decision times and diluting the impact of the introduction. Moreover, the system does not incorporate analytics to measure engagement or adapt subsequent presentations based on user behavior.

Particularly '260 to Paul discloses an electronic business card exchange system focused on storing and transferring vCard or similar formats between devices. While effective for simple data exchange, the disclosed system is constrained to basic text-based information and provides no mechanism for integrating branded media assets, curated factual panels, or synchronized storytelling elements. The absence of engagement tracking and personalization further limits the system's ability to support meaningful brand introductions or optimize recipient interactions.

Accordingly, there exists a need for a single-trigger, automated system that initiates an emotionally engaging media presentation to introduce both a brand and an individual in a sequenced manner, followed by a curated information panel that surfaces only high-value factual content. Such a system should further provide immediate interaction controls to streamline user decisions, while capturing analytics that reflect recipient behavior and preferences. By filtering extraneous information and focusing attention on relevant content, the system can improve the efficiency and effectiveness of introductions, support brand consistency, and enable data-driven optimization of future interactions.

### SUMMARY OF THE DISCLOSURE

In accordance with the present disclosure, a media introduction and curated information delivery system enables automated, sequential presentation of dynamic media followed by a guided information panel that surfaces only high-value factual content associated with a user. Unlike conventional digital business cards or website-style platforms that overwhelm recipients with static or excessive information, the disclosed system employs a trigger event such as a scan of a machine-readable code to initiate a branded media presentation, transitions seamlessly to an individualized media presentation, and synchronizes curated factual data with the presentation through a scrolling navigation interface. The system further incorporates engagement tracking, real-time customization, and machine learning-based predictive models to refine filtering, sequencing, and personalization based on recipient behavior. This architecture enhances user engagement, reduces decision time, and enables data-driven optimization of introductions, while providing robust privacy controls and opt-in mechanisms for protecting user data.

In one embodiment of the present disclosure, a media introduction and curated information delivery system is disclosed. The media introduction and curated information delivery system comprises a memory having one or more computer readable instructions, at least one processor communicatively coupled with the memory, wherein the at least one processor executing the one or more computer readable instructions stored in the memory is configured to detect, via a trigger event detection module communicatively coupled to the at least one processor, a scan of a machine-readable code being associated with a first user in real time; initiate, via a media sequencing engine communicatively coupled to the at least one processor, automatically a first dynamic media presentation for the first user, in response to detecting the scan of the machine-readable code; transit, via the media sequencing engine, from the first dynamic media presentation to a second dynamic media presentation; retrieve, via an information curation module communicatively coupled to the at least one processor, factual data associated with the first user; filter, via the information curation module, automatically non-essential information from the factual data, based at least on predefined relevance criteria; synchronize the filtered factual data as a guided information panel with the second dynamic media presentation; and display, via a scrolling navigation interface module communicatively coupled to the at least one processor, the filtered factual data synchronized with the second dynamic media presentation to a second user.

In some embodiments, the first dynamic media presentation comprises at least one of branded visual asset motion graphics, visual effects, synchronized audio, or text the second dynamic media presentation comprises at least one of company logo, tagline, animated mark, a static image of the first user with contextual information, or a video clip featuring the first user.

In some embodiments, the at least one processor executing the one or more computer readable instructions stored in the memory is configured to monitor, via an engagement tracking module communicatively coupled to the at least one processor, one or more interactions of the second user on the displayed guided information panel; and determine, via the engagement tracking module, one or more engagement metrics based at least on the monitored one or more interactions to determine behavior and preferences of the second user.

In some embodiments, the one or more engagement metrics correspond to a system-level effectiveness measure of the displayed guided information panel to the second user, and wherein the one or more engagement metrics comprises at least one of activation counts, time spent on the guided information panel, click-through rates on calls-to-action, share events, save events, or replay events, wherein the system-level effectiveness measure being used to optimize bandwidth allocation, preloading of content, or user interface responsiveness.

In some embodiments, the at least one processor executing the one or more computer readable instructions stored in the memory is configured to customize, via a customization module communicatively coupled to the at least one processor, automatically color schemes, logos, and layout templates of the first dynamic media presentation and the second dynamic media presentation in real time, based at least on the determined behavior and preference of the second user.

In some embodiments, the guided information panel comprises one or more sections configured to illuminate, outline enhance, or animate to indicate active selection of the one or more sections by the second user.

In some embodiments, the one or more sections comprises at least home, about me, mission statement, services, portfolio, reviews, why choose us, certificates/licenses, Dept. of Consumer Protection license look-up (DCP) link, frequently asked questions, 2D explainer video, press/media, events, blogs, clients, resume, property listings, menu, calendar, and public cards directory.

In some embodiments, the at least one processor is configured to protect the factual data of the first user, using data privacy controls and opt-in mechanisms.

In some embodiments, the at least one processor executing the one or more computer readable instructions stored in the memory is configured to train, via a machine learning module communicatively coupled to the at least one processor, one or more predictive models based at least on the determined behavior and preferences of the second user, the one or more predictive models being further configured to dynamically improve filtering of the factual data, synchronizing the filtered factual data, and customizing the first dynamic media presentation and the second dynamic media presentation.

In some embodiments, the at least one processor executing the one or more computer readable instructions stored in the memory is configured to render, via an interactive agent module communicatively coupled to the at least one processor, an avatar synchronized with the second dynamic media presentation, the avatar is configured to accept a natural-language input from the second user and based on which configured to execute context-specific actions including at least save contact, share, book meeting, or get a digital contact card; detect, via an autoplay orchestration module communicatively coupled to the at least one processor, autoplay restrictions, pre-buffer media, bind a compliant micro-gesture to unlock audio contexts, and insert a silent pre-roll to enable audible playback during the first dynamic media presentation and the second dynamic media presentation; record, via a contact update propagation module communicatively coupled to the at least one processor, save or share events, maintain a registry of the second user, and transmit update notifications with granular change-sets and deep-links to relevant sections of the guided information panel; and import and transform, via an asset ingestion module communicatively coupled to the at least one processor, third-party creative assets into sequenced presentations consumable by the media sequencing engine.

In some embodiments, the media introduction and curated information delivery system further comprises a team management dashboard configured to define schema templates and propagate global updates across the digital contact card of the first user, supporting role-based access, single sign-on, and lifecycle synchronization.

In some embodiments, the scrolling navigation interface module further comprises sponsored placements within one or more sections, the placements being selected and ordered using engagement metrics or predictive models.

In an aspect of the present disclosure, a method is disclosed. The method comprises detecting, via at least one processor communicatively coupled with a memory and using a trigger event detection module communicatively coupled to the at least one processor, a scan of a machine-readable code in real time; initiating, via the at least one processor using a media sequencing engine communicatively coupled to the at least one processor, automatically a first dynamic media presentation for a first user, in response to detecting the scan of the machine-readable code; transiting, via the at least one processor using the media sequencing engine, from the first dynamic media presentation to a second dynamic media presentation; retrieving, via the at least one processor using an information curation module communicatively coupled to the at least one processor, factual data associated with the first user; filtering, via the at least one processor using the information curation module, automatically non-essential information from the factual data, based at least on predefined relevance criteria; synchronizing, via the at least one processor, the filtered factual data as a guided information panel with the second dynamic media presentation; and displaying, via the at least one processor using a scrolling navigation interface module communicatively coupled to the at least one processor, the filtered factual data synchronized with the second dynamic media presentation to a second user.

In an aspect of the present disclosure, a non-transitory computer-readable medium storing instructions that, when executed by at least one processor, cause the at least one processor to detect, via a trigger event detection module communicatively coupled to the at least one processor, a scan of a machine-readable code being associated with a first user in real time; initiate, via a media sequencing engine communicatively coupled to the at least one processor, automatically a first dynamic media presentation for the first user, in response to detecting the scan of the machine-readable code; transit, via the media sequencing engine, from the first dynamic media presentation to a second dynamic media presentation; retrieve, via an information curation module communicatively coupled to the at least one processor, factual data associated with the first user; filter, via the information curation module, automatically non-essential information from the factual data based at least on a predefined relevance criteria; synchronize the filtered factual data as a guided information panel with the second dynamic media presentation; and display, via a scrolling navigation interface module communicatively coupled to the at least one processor, the filtered factual data synchronized with the second dynamic media presentation to a second user.

Other features and aspects of the disclosure will be apparent from the following description, list of elements, and the accompanying drawings.

### BRIEF DESCRIPTION OF THE DRAWINGS

Various embodiments of the present disclosure can be more readily understood and appreciated from the following descriptions of various embodiments of the present disclosure when read in conjunction with the accompanying drawings, in which:

FIG. 1 illustrates a block diagram of a media introduction and curated information delivery system according to an embodiment of the present disclosure;

FIG. 2 illustrates a block diagram of the server according to an embodiment of the present disclosure;

FIG. 3 illustrates an exemplary user interface view of a scrolling panel showing a “Home” module icon in an active illuminated state with associated action buttons according to an embodiment of the present disclosure;

FIG. 4 illustrates an exemplary user interface view of the scrolling panel showing the “Services” button in an active illuminated state with associated action buttons according to an embodiment of the present disclosure;

FIG. 5 illustrates an exemplary user interface view of the scrolling panel showing the “FAQs” button in an active illuminated state with associated action buttons according to an embodiment of the present disclosure;

FIG. 6 illustrates an exemplary digital contact card of the first user according to an embodiment of the present disclosure;

FIG. 7 illustrates an “About Me” section of the digital contact card of the first user according to an embodiment of the present disclosure;

FIG. 8 illustrates the a searchable and filtered directory of other users according to an embodiment of the present disclosure; and

FIG. 9 illustrates a flowchart showing a method according to an embodiment of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

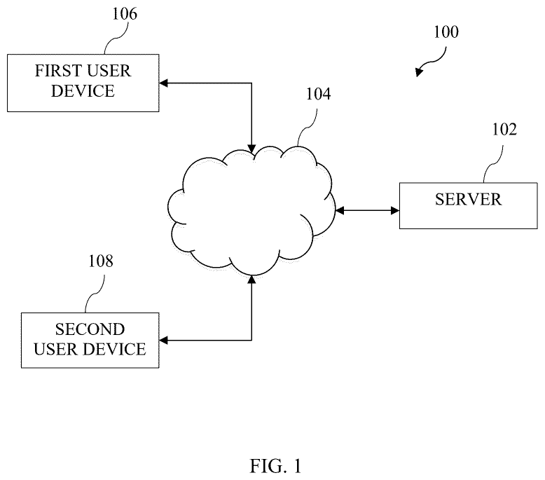

FIG. 1 illustrates a block diagram of a media introduction and curated information delivery system 100 according to an embodiment of the present disclosure.

In some embodiments, the media introduction and curated information delivery system 100 is generally configured to enable automated initiation of a dynamic media presentation followed by delivery of curated factual information from a first user to a second user through a server 102 and a network 104. The objective of the media introduction and curated information delivery system 100 is to provide a seamless and engaging introduction experience that reduces reliance on static business cards or conventional website-style navigation, while ensuring that the second user receives high-value, relevant factual information in a structured and interactive format.

In some embodiments, the media introduction and curated information delivery system 100 comprises the network 104 configured to communicatively couple the server 102 with a first user device 106 and a second user device 108. In some embodiments, the server 102 may be implemented as one or more computing devices configured to execute computer-readable instructions for carrying out functions of the media introduction and curated information delivery system 100. In various embodiments, the server 102 may comprise computer-readable instructions, input/output interfaces, and communication components for interacting with the network 104. The server 102 may be deployed in different forms including, at least a physical server, a virtual server, a cloud-hosted instance, or a distributed computing environment. In operation, the server 102 may be configured to manage the detection of trigger events, initiation of dynamic media presentations, retrieval and filtering of factual data, synchronization of curated information, and delivery of the resulting guided information panel to the second user device 108.

In some embodiments, the server 102 may be configured to detect a scan of a machine-readable code in real time. In some embodiments, the server 102 may receive, via the network 104, scan data transmitted by at least one of the first user device 106 or the second user device 108. In some embodiments, the scan data may indicate that a machine-readable code associated with the first user has been scanned. The scan data may include an encoded identifier that the server 102 may be decoded to recognize the first user and to determine a corresponding record for subsequent processing. Real-time detection of the scan of the machine-readable code in real time indicates that, upon receipt of the scan data, the server 102 may process the scan without intentional delay so that downstream actions may be initiated substantially immediately (as described further).

In some embodiments, the server 102 may further be configured to initiate automatically a first dynamic media presentation for the first user, in response to detecting the scan of the machine-readable code. In some embodiments, upon identifying the first user via the scan, the server 102 may initiate the first dynamic media presentation associated with the first user. The server 102 may retrieve one or more media assets that form the first dynamic media presentation. The one or more media assets may include at least video clips, motion graphics, audio tracks, and text overlays. The server 102 may check each of the one or more media assets for availability and format compatibility with the second user device 108. The server 102 may also apply any first user approved privacy or delivery restrictions before proceeding. In some embodiments, the first dynamic media presentation comprises at least one of branded visual asset motion graphics, visual effects, synchronized audio, or text.

In some embodiments, the server 102 may further be configured to transit from the first dynamic media presentation to a second dynamic media presentation. In some embodiments, the transition may occur automatically upon completion of the first dynamic media presentation. In some embodiments, the server 102 may apply a seamless transition effect, such as a fade, dissolve, or animated overlay, to maintain continuity of the second user's experience. In some embodiments, the second dynamic media presentation may comprise at least one of a company logo, a tagline, an animated mark, a static image of the first user with contextual information, or a video clip featuring the first user. For example, the server 102 may display the company logo and tagline together at the start of the second dynamic media presentation to reinforce brand recognition. In another example, the second dynamic media presentation may include a static image of the first user accompanied by contextual details such as name, role, or location.

In still another example, the second dynamic media presentation may provide a short video clip featuring the first user delivering a spoken introduction. In some embodiments, the server 102 may determine a composition of the second dynamic media presentation based on predefined templates stored in the memory of the media introduction and curated information delivery system 100. In some embodiments, the composition of the second dynamic media presentation refers to the specific arrangement and selection of constituent media elements within the second dynamic media presentation. The server 102 may select among available company logo, taglines, images, or video clips associated with the first user. The selection may also be influenced by device capabilities of the second user device 108, such as screen size or supported formats. Once the second dynamic media presentation is assembled, the server 102 may stream or transmit it to the second user device 108 for continuous playback following the first dynamic media presentation.

In some embodiments, the server 102 may further be configured to retrieve factual data associated with the first user. In some embodiments, the factual data may be stored in a database accessible to the media introduction and curated information delivery system 100. The factual data may include at least contact details, professional background, certifications, portfolio items, service descriptions, or links to verified third-party references. The retrieval of the factual data may be performed using the encoded identifier obtained from the scan of the machine-readable code so that the correct factual data set is associated with the identified first user. In some embodiments, the server 102 may verify integrity and relevance of the factual data during retrieval. The server 102 may check whether the factual data is current, whether the first user has authorized the factual data for presentation, and whether privacy or opt-in preferences restrict certain items from being included. The server 102 may further organize the factual data into structured categories, such as personal details, professional details, achievements, or testimonials, to facilitate subsequent filtering and synchronization with the second dynamic media presentation.

In some embodiments, the server 102 may further be configured to filter non-essential information from the factual data, based at least on predefined relevance criteria. In some embodiments, the predefined relevance criteria may be established by the first user, a system administrator, or may be determined automatically by the media introduction and curated information delivery system 100. The predefined relevance criteria may include factors such as topical importance, recency, user role, or industry-specific significance. In some embodiments, the filtering process may exclude redundant, outdated, or low-priority information from the factual data before presentation to the second user device 108. For example, outdated certifications or inactive service offerings may be removed from the factual data. In another example, lengthy text descriptions may be condensed to highlight only the most relevant points.

In some embodiments, the server 102 may also apply contextual rules to prioritize data that aligns with the second user's likely intent, such as highlighting a current project portfolio when the second user is a prospective client. In some embodiments, the filtering non-essential information from the factual data may be adaptive and may update automatically as relevance criteria evolve. The server 102 may maintain a log of engagement metrics or user interactions from prior presentations and may use these as feedback to refine future filtering decisions. By filtering non-essential information, the media introduction and curated information delivery system 100 may ensure that only high-value factual data is prepared for synchronization with the second dynamic media presentation, thereby improving clarity, engagement, and decision-making efficiency for the second user.

This selective filtering ensures that only relevant factual data is synchronized with the second dynamic media presentation and displayed within the guided information panel. By excluding non-essential information, the system reduces the overall amount of data that must be processed, transmitted, and rendered. As a result, the filtering performed by the server provides the technical advantages of reducing processing latency and conserving bandwidth consumption during transitions between the first dynamic media presentation and the second dynamic media presentation. These improvements enhance responsiveness of the scrolling navigation interface and enable the at least one processor to operate more efficiently in real-time environments, thereby improving the overall performance of the system.

In some embodiments, the server 102 may further be configured to synchronize the filtered factual data as a guided information panel with the second dynamic media presentation. In some embodiments, the guided information panel may be generated in real time and overlaid or displayed in association with the second dynamic media presentation on the second user device 108. Synchronization may include aligning the timing, sequencing, or positioning of the factual data with visual or audio cues of the second dynamic media presentation so that the transition from media to factual content appears seamless to the second user. In some embodiments, the guided information panel may comprise one or more sections with visual effects configured to illuminate, outline, enhance, or animate to indicate active selection of the one or more sections by the second user. Such visual effects may provide feedback during navigation and encourage interaction with the displayed content. The animation or highlighting may be triggered when the second user selects, hovers, or scrolls to a particular section, thereby improving usability and engagement.

In some embodiments, the one or more sections of the guided information panel may comprise at least home, about me, mission statement, services, portfolio, reviews, why choose us, certificates/licenses, Dept. of Consumer Protection license look-up (DCP) link, frequently asked questions, 2D explainer video, press/media, events, blogs, clients, resume, property listings, menu, calendar, and public cards directory. Each of the one or more sections may be selectively populated with corresponding portions of the filtered factual data. For example, the “portfolio” section may include curated project samples, the “certificates/licenses” section may present validated credentials, and the “Dept. of Consumer Protection license look-up (DCP) link” section may provide direct access to a transactional portal. By structuring the factual data into interactive sections, the guided information panel may allow the second user to navigate efficiently while avoiding overload from non-essential information.

In some embodiments, the server 102 may further be configured to display the filtered factual data synchronized with the second dynamic media presentation to a second user. The display may be presented on the second user device 108 using a scrolling navigation interface that enables the second user to move through the guided information panel smoothly without interruption of the second dynamic media presentation. In some embodiments, the scrolling navigation interface may support vertical or horizontal scrolling, swipe gestures, or continuous scroll modes to provide intuitive access to the sections of the guided information panel. In some embodiments, the scrolling navigation interface may further allow the second user to access interactive controls embedded within the displayed factual data.

For example, the second user may be able to expand a section for additional detail, activate a call-to-action button, or trigger playback of an embedded video clip, while the second dynamic media presentation continues in a synchronized manner. This integration ensures that the factual data remains contextually linked with the media content, thereby enhancing the overall engagement and effectiveness of the presentation. In some embodiments, the media introduction and curated information delivery system 100 may be configured such that the layout, size, and positioning of the guided information panel within the scrolling navigation interface are automatically optimized for the display characteristics of the second user device 108. For instance, on a mobile device, the guided information panel may be presented in a collapsible format with touch-based navigation, whereas on a larger desktop display, multiple sections of the panel may be simultaneously visible to the second user. Such adaptability ensures consistent user experience across different device types.

In some embodiments, the server 102 may further be configured to monitor one or more interactions of the second user on the displayed guided information panel. Such interactions may include at least scrolling activity, section selections, click-throughs on embedded links, hover durations over particular elements, playback of video or audio clips, and activations of calls-to-action. By continuously monitoring these interactions in real time, the media introduction and curated information delivery system 100 is able to capture fine-grained behavioral data that reflects how the second user engages with the synchronized media content and factual information. In some embodiments, the server 102 may further be configured to determine one or more engagement metrics based at least on the monitored interactions of the second user. The engagement metrics may correspond to quantitative and qualitative measures such as activation counts, time spent within one or more sections of the guided information panel, click-through rates on interactive elements, save events, share events, or replay events.

The determination of such engagement metrics enables the media introduction and curated information delivery system 100 to evaluate the extent and quality of user engagement with the content. In some embodiments, the engagement metrics may further be analyzed to determine behavior and preferences of the second user. For example, frequent interaction with a “services” section may indicate commercial interest, whereas extended time spent viewing a “portfolio” section may suggest an interest in prior work. Similarly, repeated replays of an introductory video clip may highlight strong attention to brand messaging. This analysis provides valuable insights into the preferences and intent of the second user, enabling subsequent customization or optimization of the media introduction and curated information delivery system 100. In some embodiments, the one or more engagement metrics correspond to an effectiveness of the displayed guided information panel to the second user, and wherein the one or more engagement metrics comprises at least one of activation counts, time spent on the guided information panel, click-through rates on calls-to-action, share events, save events, and replay events, wherein the effectiveness of the displayed guided information panel is defined as a measure of the one or more engagement metrics.

In some embodiments, the server 102 may further be configured to customize automatically one or more visual and structural elements of the first dynamic media presentation and the second dynamic media presentation in real time, based at least on the determined behavior and preferences of the second user. The one or more visual and structural elements may include modification of color schemes, substitution of logos, and selection of layout templates to align the media presentations with the engagement profile of the second user. In some embodiments, the customization may be applied adaptively and without requiring manual intervention. For example, if the engagement metrics indicate that the second user repeatedly interacts with professional credentials or certifications, the media introduction and curated information delivery system 100 may adjust the color palette of the guided information panel to emphasize a formal or authoritative visual style.

Further, if the behavior of the second user shows a preference for creative portfolio sections, the media introduction and curated information delivery system 100 may dynamically introduce brighter color schemes, animated logos, or alternate layout templates that convey a more creative tone. In some embodiments, the server 102 may further synchronize such customization across both the first dynamic media presentation and the second dynamic media presentation, thereby ensuring a unified and consistent user experience. The real-time adaptation of visual and structural elements based on behavioral cues allows the media introduction and curated information delivery system 100 to deliver a presentation that is not only personalized but also emotionally resonant with the second user, thereby improving engagement effectiveness and conversion potential.

In some embodiments, the server 102 may be configured to protect the factual data of the first user by employing data privacy controls and opt-in mechanisms. Such data privacy controls and opt-in mechanisms may include encryption of the factual data during storage and transmission, access restrictions based on the first user's permissions, and anonymization of non-essential information. The opt-in mechanisms may allow the first user to selectively authorize which portions of the factual data are made available within the guided information panel, thereby ensuring that the presentation of information remains consistent with the privacy preferences of the first user while maintaining compliance with applicable data protection standards.

In some embodiments, the server 102 may be configured to include a machine learning (ML) module that enables the training of one or more predictive models based at least on the behavior and preferences of the second user. The predictive models may receive as input the engagement metrics determined from user interactions, such as activation counts, time spent on sections of the guided information panel, and click-through rates on calls-to-action. By processing these engagement metrics over multiple sessions, the ML module may generate adaptive patterns that reflect the evolving interests, browsing habits, and contextual preferences of the second user.

In some embodiments, the one or more predictive models trained by the ML module may be further configured to dynamically improve multiple aspects of the media introduction and curated information delivery system 100. In particular, the predictive models may refine the filtering of factual data to emphasize only the most relevant content for presentation, synchronize the filtered factual data with the second dynamic media presentation in a context-aware manner, and customize visual elements of both the first dynamic media presentations and second dynamic media presentations, including layouts, logos, and color schemes. Such adaptive improvements may provide a personalized and continuously optimized experience for the second user, while simultaneously enhancing the engagement effectiveness of the system over time.

In some embodiments, the server 102 may be further configured to render an avatar synchronized with the second dynamic media presentation, the avatar is configured to accept a natural-language input from the second user and based on which configured to execute context-specific actions including at least save contact, share, book meeting, or get a digital contact card. In some implementations, the avatar may be synchronized with transitions between the first dynamic media presentation and the second dynamic media presentation, such that its rendered expressions or gestures visually align with the sequencing of branded visual assets, motion graphics, or contextual information of the first user.

In some embodiments, the avatar may further operate in coordination with the guided information panel by highlighting or emphasizing one or more sections including about me, services, portfolio, events, or calendar, in response to the natural-language input. By aligning the avatar's responses with the scrolling navigation interface, the system may provide the second user with an interactive means of engaging with factual data that has already been filtered according to predefined relevance criteria. The avatar may further facilitate continuity of engagement by prompting the second user to revisit, replay, or save portions of the second dynamic media presentation, thereby reinforcing the system-level effectiveness measure that is determined through monitored interactions.

The avatar rendered, via the server 102, is configured to perform phoneme-to-viseme mapping, where each phoneme, representing a distinct unit of sound in speech, is mapped to a corresponding viseme, representing the associated mouth shape or facial movement. This mapping enables the avatar to visually articulate speech in a manner that is synchronized with audio content from the second dynamic media presentation. By dynamically translating phonemes into visemes in real time, the system ensures that the avatar's lip and facial movements accurately reflect the spoken content, enhancing the realism and interactivity of the presentation.

In some embodiments, the phoneme-to-viseme mapping with an end-to-end latency is performed in below 300 milliseconds that provides the technical advantage of maintaining natural synchronization between the avatar's rendered lip movements and the corresponding audio output in the second dynamic media presentation. By constraining the latency threshold, the avatar may respond to natural-language input from the second user while executing context-specific actions such as save contact, share, book meeting, or get a digital contact card, without perceptible delay. This synchronization reduces cognitive dissonance and ensures smoother, more immersive interaction with the guided information panel. Additionally, the reduced latency enhances real-time responsiveness of the avatar compositor, preserving display continuity and improving overall rendering efficiency during transitions between the first dynamic media presentation and the second dynamic media presentation.

In some embodiments, the server 102 may be further configured to detect autoplay restrictions, pre-buffer media, bind a compliant micro-gesture to unlock audio contexts, and insert a silent pre-roll to enable audible playback during the first dynamic media presentation and the second dynamic media presentation. In some embodiments, handling of the autoplay restrictions may ensure that the transition from the first dynamic media presentation to the second dynamic media presentation remains uninterrupted and synchronized with the filtered factual data displayed through the guided information panel. By associating the compliant micro-gesture with unlocking audio contexts, the system may preserve continuity of branded visual assets, synchronized audio, or contextual information of the first user without requiring disruptive manual actions from the second user. The silent pre-roll may further operate to maintain consistency across different playback environments, thereby enhancing responsiveness of the scrolling navigation interface and ensuring that engagement metrics such as activation counts, replay events, or time spent remain representative of actual user behavior rather than technical playback limitations.

In some embodiments, the server 102 may be further configured to record save or share events, maintain a registry of the second user, and transmit update notifications with granular change-sets and deep-links to relevant sections of the guided information panel. In some embodiments, such recording of save or share events may contribute directly to the engagement metrics determined from the monitored interactions of the second user, thereby enriching the system-level effectiveness measure. Maintaining a registry of the second user may allow continuity across multiple sessions, such that customized color schemes, logos, or layout templates of the first dynamic media presentation and the second dynamic media presentation can be consistently applied based on previously observed behavior and preferences. The transmission of update notifications with granular change-sets and deep-links to relevant sections of the guided information panel may further enable the second user to directly access sections such as services, portfolio, events, or blogs, without navigating sequentially through all available sections. This streamlined access may increase time efficiency, reinforce replay events, and enhance the likelihood of continued interaction, thereby optimizing both user interface responsiveness and content delivery effectiveness.

In some embodiments, the server 102 may be further configured to import and transform third-party creative assets into sequenced presentations consumable by the media sequencing engine. In some embodiment, the imported third-party creative assets may include branded visual asset motion graphics, visual effects, synchronized audio, or text, which can be adapted into the first dynamic media presentation, as well as logos, taglines, animated marks, static images, or video clips that may be aligned with the second dynamic media presentation. By transforming such assets into sequenced presentations, consistency can be maintained across transitions, ensuring that the contextual information of the first user is reinforced while still incorporating external content. Integration of these assets into the guided information panel may further support interactive sections such as press/media, property listings, or public cards directory, thereby enriching the overall factual data presented to the second user. The transformation process may additionally preserve synchronization between the imported content and the scrolling navigation interface, so that engagement metrics such as click-through rates, share events, or replay events remain accurate reflections of second user behavior.

In some embodiments, the first user device 106 and the second user device 108 may each be implemented as, a smartphone, tablet computer, laptop computer, desktop computer, wearable device, or any other network-enabled computing device capable of executing client-side applications and communicating with the server 102 via the network 104. The first user device 106 and the second user device 108 may each comprise at least one processor, memory, input/output interface, and a display for rendering the first dynamic media presentation, the second dynamic media presentation, and the guided information panel. In certain embodiments, the first user device 106 may operate primarily to initiate content associated with the first user, while the second user device 108 may be configured to receive, display, and interact with such content. However, in alternative embodiments, either the first user device 106 or the second user device 108 may interchangeably perform functions depending on user role, device capabilities, or system configuration, thereby ensuring flexibility and broad applicability of the system architecture.

In some embodiments, the “first user” may refer to an individual having a digital contact card and whose digital contact card or associated information is made accessible to the public. In some embodiment, the “second user” may refer to an individual who scans the machine-readable code associated with the first user and receives and looks at the digital contact card on the second user device 108. It will be apparent to one skilled in the art that the above-mentioned components of the system 100 have been provided only for illustration purposes, without departing from the scope of the disclosure.

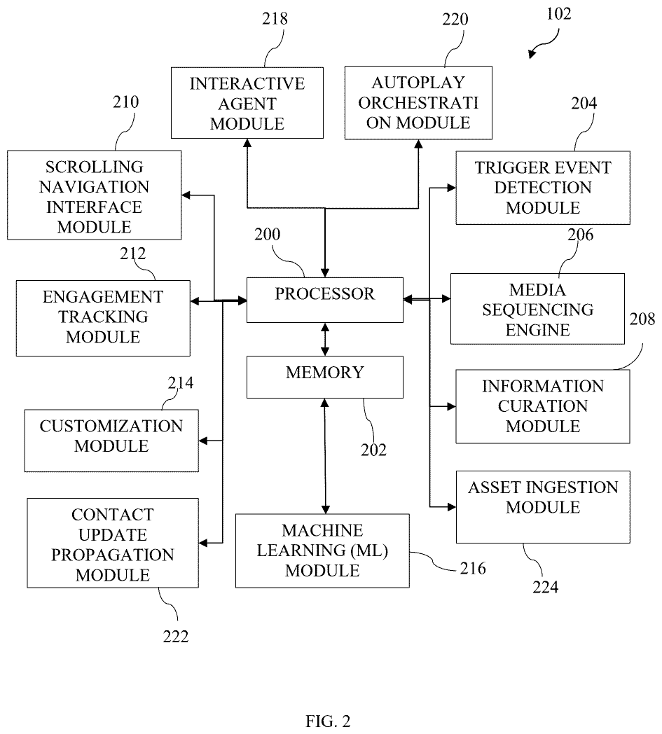

FIG. 2 illustrates a block diagram of the server 102 according to an embodiment of the present disclosure.

In some embodiments, the server 102 comprises at least one processor 200 and a memory 202 communicatively coupled to the at least one processor 200. Further, the server 102 comprises a trigger event detection module 204, a media sequencing engine 206, an information curation module 208, a scrolling navigation interface module 210, an engagement tracking module 212, a customization module 214, and a machine learning (ML) module 216. Referring now to FIG. 2, in some embodiments, the media introduction and curated information delivery system 100 may be implemented with at least one processor 200 communicatively coupled to the memory 202. The memory 202 may store one or more computer-readable instructions which, when executed by the at least one processor 200, configure the media introduction and curated information delivery system to carry out the various operations described herein. To support modular functionality, the media introduction and curated information delivery system 100 may include one or more software or hardware-based modules that operate in cooperation with the at least one processor 200 and the memory 202 to perform discrete tasks corresponding to different stages of the media introduction and curation process.

In some embodiments, the at least one processor 200 executing instructions stored in the memory 202 may be configured to operate in association with the trigger event detection module 204. The trigger event detection module 204 may be communicatively coupled to the at least one processor 200 and adapted to detect, in real time, the scan of a machine-readable code such as a QR code, bar code, near-field communication (NFC) tag, or similar trigger input. In some embodiments, the trigger event detection module 204 may process input signals received from a sensor, camera, or scanning interface of the first user device 106, and relay the scan event to the at least one processor 200 for immediate recognition. The at least one processor 200, in coordination with the memory 202, may then validate the scan data, initiate a corresponding session, and log the trigger event for subsequent processing. This correlation of trigger event detection module 204, the at least one processor 200, and the memory 202 ensures both accurate detection and reliable initiation of downstream media presentation workflows.

In some embodiments, upon detecting the scan of the machine-readable code, the at least one processor 200, executing computer-readable instructions stored in the memory 202, may further be configured to operate in conjunction with the media sequencing engine 206. The media sequencing engine may be communicatively coupled to the at least one processor 200 and designed to automatically initiate the first dynamic media presentation for the first user in direct response to the detected scan event. The media sequencing engine 206 may retrieve one or more pre-stored media assets from the memory 202 or from an associated data repository and arrange in a predefined sequence. These one or more pre-stored assets may include, for example, branded visual asset motion graphics, synchronized audio tracks, visual effects, or stylized text elements.

The at least one processor 200 may execute the sequencing logic of the media sequencing engine 206 to ensure that the first dynamic media presentation begins seamlessly and without requiring manual intervention by the first user. In some embodiments, by coordinating the sequencing operations with the at least one processor 200 and the memory 202, the media sequencing engine 206 provides a controlled and automated introduction that immediately captures attention following the scan event. This ensures that the transition from the trigger input to the display of branded media is rapid, consistent, and emotionally engaging, thereby reducing latency and increasing the overall effectiveness of the media introduction and curated information delivery system 100.

In some embodiments, the at least one processor 200, executing computer-readable instructions stored in the memory 202, may further be configured to operate in conjunction with the media sequencing engine 206 to manage a transition from the first dynamic media presentation to the second dynamic media presentation. The transition may occur automatically after completion of the first presentation or upon detection of a predefined trigger condition, thereby ensuring continuity in the delivery of information to the second user. The term “predefined trigger condition” refers to one or more preset events or parameters, such as time lapse, user interaction, or system signal, that when detected cause automatic transition between media presentations. The media sequencing engine 206 may direct the at least one processor 200 to retrieve from the memory 202, or from an external repository, one or more assets that compose the second dynamic media presentation.

In some embodiments, the second dynamic media presentation may include at least one of a company logo, tagline, animated mark, a static image of the first user with contextual information, or a video clip featuring the first user. The media sequencing engine 206 may further coordinate timing, order, and blending of these one or more assets to achieve a smooth and contextually relevant transition between the first dynamic media presentation and the second dynamic media presentation. By leveraging the processing power of the at least one processor 200 and the structured asset storage within the memory 202, the media sequencing engine 206 ensures that the transition is executed without interruption or delay. This transition enhances the emotional engagement initiated by the first dynamic media presentation while introducing curated factual elements in the second dynamic media presentation, thereby aligning the sequence with the objectives of the media introduction and curated information delivery system 100.

In some embodiments, the at least one processor 200, in conjunction with the memory 202, may be configured to retrieve, via an information curation module 208 communicatively coupled to the at least one processor 200, the factual data associated with the first user. in some embodiments, the information curation module 208 may be configured to access one or more databases, local repositories, or remote storage systems where such factual data is maintained. The factual data may include, for example, professional details, business identifiers, portfolio items, credentials, or other verified information associated with the first user. By coordinating with the at least one processor 200 and memory 202, the information curation module 208 ensures that the factual data is retrieved in real time, enabling immediate integration into the ongoing dynamic media presentation sequence.

In some embodiments, the at least one processor 200, in conjunction with the memory 202, may be configured to filter, via the information curation module 208 communicatively coupled to the at least one processor 200, non-essential information from the retrieved factual data, based at least on predefined relevance criteria. The filtering process may selectively eliminate redundant, outdated, or less pertinent information, thereby retaining only factual content that carries immediate value for presentation. The predefined relevance criteria may include contextual importance, recency, or user-defined preferences, ensuring that the filtered factual data is concise and meaningful for display.

This selective filtering ensures that only relevant factual data is synchronized with the second dynamic media presentation and displayed within the guided information panel. By excluding non-essential information, the media introduction and curated information delivery system 100 reduces the overall amount of data that must be processed, transmitted, and rendered. As a result, the filtering performed by the information curation module 208 provides the technical advantages of reducing processing latency and conserving bandwidth consumption during transitions between the first dynamic media presentation and the second dynamic media presentation. These improvements enhance responsiveness of the scrolling navigation interface and enable the at least one processor to operate more efficiently in real-time environments, thereby improving the overall performance of the system.

In some embodiments, the filtered factual data may be synchronized by the at least one processor 200 with the second dynamic media presentation, thereby forming a guided information panel. The synchronization process may align the factual data with the visual or interactive sequence of the second dynamic media presentation, creating a cohesive and structured flow of information. The guided information panel may be composed of one or more sections configured to illuminate, outline, enhance, or animate in response to active selection by the second user, and may include sections such as home, about me, mission statement, services, portfolio, reviews, why choose us, certificates/licenses, Dept. of Consumer Protection license look-up (DCP) link, frequently asked questions, 2D explainer video, press/media, events, blogs, clients, resume, property listings, menu, calendar, and public cards directory.

In some embodiments, the at least one processor 200 may further be configured to display, via a scrolling navigation interface module 210 communicatively coupled to the at least one processor 200, the filtered factual data synchronized with the second dynamic media presentation to the second user. The scrolling navigation interface module 210 may present the guided information panel in an interactive manner, allowing the second user to navigate through the various sections with minimal effort. The filtered factual data synchronized with the second dynamic media presentation enhances accessibility and user engagement by ensuring that high-value factual data remains synchronized with the second dynamic media presentation, while maintaining an intuitive and visually engaging interface.

In some embodiments, the scrolling navigation interface module 210 further comprises sponsored placements within one or more sections of the guided information panel. These placements may be presented alongside sections such as services, portfolio, events, blogs, property listings, or public cards directory, while maintaining synchronization with the second dynamic media presentation. The sponsored placements are configured to appear in the same manner as other sections of the guided information panel, thereby ensuring that the second user experiences seamless navigation without disruption of contextual information of the first user.

The sponsored placements within the scrolling navigation interface module 210 are selected and ordered using engagement metrics or predictive models. Engagement metrics such as activation counts, time spent, click-through rates, share events, save events, or replay events may be used to determine which placements are most relevant to the second user. Predictive models trained on the behavior and preferences of the second user may further refine ordering by dynamically adjusting placement priority to improve system-level effectiveness measures. In this way, sponsored placements are integrated responsively into the guided information panel, reinforcing both factual data delivery and interactive customization.

In some embodiments, the at least one processor 200, in conjunction with the memory 202, may be configured to monitor, via an engagement tracking module 212 communicatively coupled to the at least one processor 200, one or more interactions of the second user on the displayed guided information panel. The interactions may include navigation through sections of the panel, selections of links, or activations of embedded media. By continuously monitoring such actions, the engagement tracking module 212 may collect detailed activity logs that reflect how the second user interacts with the synchronized content.

In some embodiments, the engagement tracking module 212 may further be configured to determine one or more engagement metrics based at least on the monitored one or more interactions to assess the behavior and preferences of the second user. The one or more engagement metrics may correspond to an effectiveness of the displayed guided information panel to the second user, wherein the effectiveness is defined as a measure of the one or more engagement metrics. The engagement metrics may comprise, for example, activation counts, time spent on the guided information panel, click-through rates on calls-to-action, share events, save events, and replay events. These one or more engagement metrics may enable the at least one processor 200 to identify patterns in user behavior, gauge the level of interest in particular sections, and refine the structure and presentation of the guided information panels to better match the behavior and preferences.

In some embodiments, the at least one processor 200, in conjunction with the memory 202, may be configured to customize, via the customization module 214 communicatively coupled to the at least one processor 200, the visual and structural aspects of the first dynamic media presentation and the second dynamic media presentation. The customization may be performed automatically in real time, based at least on the determined behavior and preferences of the second user as identified by the engagement tracking module. The customization module 214 may dynamically alter color schemes, logos, and layout templates to enhance the visual appeal and relevance of the media presentations. For example, if the second user demonstrates repeated interaction with certain brand-related elements, the at least one processor 200 may emphasize such elements by applying a consistent color scheme, enlarging the associated logo, or adjusting the layout to highlight the preferred content. By adapting the presentations in this manner, the at least one processor 200 may deliver a personalized and contextually relevant media experience that resonates with the second user and increases overall engagement.

The customization of the layout templates of the first dynamic media presentation and the second dynamic media presentation in real time based at least on the determined behavior and preferences of the second user provides the technical advantage of being automatically adapted to improve rendering efficiency and reduce client-side processing load. By aligning visual arrangements, color schemes, and logos dynamically with the observed interactions of the second user, the media introduction and curated information delivery system 100 minimizes redundant rendering operations and avoids unnecessary recalculation of static elements. This automatic adaptation ensures that only those components relevant to the behavior and preferences of the second user are refreshed, thereby conserving local device resources. As a result, the second user device 108 experiences faster presentation updates, smoother transitions, and reduced latency, all while maintaining synchronization between the guided information panel and the second dynamic media presentation.

In some embodiments, the at least one processor 200, in conjunction with the memory 202, may be configured to train, via the machine learning (ML) module 216 communicatively coupled to the at least one processor 200, one or more predictive models. The training may be performed based at least on the determined behavior and preferences of the second user, as obtained through the engagement tracking module 212. By analyzing recurring interaction patterns and contextual engagement data, the ML module 216 may enable the predictive models to evolve over time, thereby refining the system's ability to anticipate user needs and responses.

Further, the ML module 216 is configured to conduct multi-turn conversations, answers queries, and proactively asks clarifying questions. Further, the ML module 216 is configured to generate a response via at least one of speech by lip-syncing the avatar, on screen captions having text, and recording conversations. In some embodiments, the lip-syncing and gestures are synchronized to generated speech with sub-frame latency.

In some embodiments, training one or more predictive models based at least on the determined behavior and preferences of the second user provides the technical advantage of reducing latency in synchronizing the filtered factual data with the second dynamic media presentation. The one or more predictive models are further adapted to customize the first dynamic media presentation and the second dynamic media presentation in a manner that minimizes bandwidth usage and enhances display continuity on the client device, thereby ensuring smoother real-time responsiveness and improved system-level effectiveness. The customization of the first dynamic media presentation and the second dynamic media presentation not only optimizes bandwidth utilization but also decreases the frequency of redundant rendering operations, lowering the overall processing demand on the client device. As a result, the system delivers a continuous, contextually synchronized experience that adapts in real time while maintaining efficient resource consumption.

The one or more predictive models may be further configured to dynamically improve multiple aspects of the at least one processor's operations, including filtering of the factual data, synchronizing the filtered factual data with the second dynamic media presentation, and customizing the first dynamic media presentation and the second dynamic media presentation. For example, as the predictive models recognize that the second user consistently engages more with professional credentials than with general biographical content, the at least one processor 200 may automatically prioritize those credentials in the guided information panel. Similarly, the predictive models may adjust presentation sequencing, color schemes, or layout templates in real time to optimize relevance and engagement. Through such adaptive learning, the at least one processor 200 may continually enhance both efficiency and user experience.

In some embodiments, the at least one processor 200 executing the one or more computer readable instructions stored in the memory is further configured to render, via an interactive agent module 218 communicatively coupled to the at least one processor 200, an avatar synchronized with the second dynamic media presentation. The synchronization allows the avatar to appear in alignment with transitions of company logos, taglines, animated marks, static images, or video clips of the first user, such that the avatar remains contextually bound to the second dynamic media presentation. By doing so, the interactive agent module 210 ensures that the filtered factual data, already synchronized with the second dynamic media presentation, may be delivered in a more engaging form to the second user. In some embodiments, the avatar is displayed over a transparent plane aligned to a home screen while a background video remains active.

In some embodiments, the interactive agent module 218 further enables the avatar to accept a natural-language input from the second user, and based on such input, execute context-specific actions including at least save contact, share, book meeting, or get a digital contact card. These actions may be reflected within the guided information panel that is displayed through the scrolling navigation interface. For instance, a save contact or share command may correspond to a monitored interaction that contributes toward engagement metrics, while a book meeting or get a digital contact card action may extend the second user's interaction time with the guided information panel. In this manner, the avatar operates as a responsive element of the second dynamic media presentation, while remaining directly linked to the behavior and preferences of the second user.

In some embodiments, the at least one processor 200 executing the one or more computer readable instructions stored in the memory is configured to detect, via an autoplay orchestration module 220 communicatively coupled to the at least one processor 200, autoplay restrictions that may otherwise prevent immediate initiation of synchronized audio in the first dynamic media presentation or the second dynamic media presentation. The autoplay orchestration module 220 is further configured to pre-buffer media so that transitions between branded visual asset motion graphics, visual effects, synchronized audio, or contextual information of the first user occur without perceptible delay. By performing these operations in advance, the media introduction and curated information delivery system 100 maintains continuity of sequencing between the first dynamic media presentation and the second dynamic media presentation.

In some embodiments, the autoplay orchestration module 220 is also configured to bind a compliant micro-gesture to unlock audio contexts and to insert a silent pre-roll to enable audible playback during both the first dynamic media presentation and the second dynamic media presentation. Binding the compliant micro-gesture ensures that the second user may unlock synchronized audio without disruptive manual steps, while the silent pre-roll establishes an audio context that complies with playback environments. Together, binding the compliant micro-gesture enhance responsiveness of the scrolling navigation interface and preserve the alignment of filtered factual data synchronized with the second dynamic media presentation, allowing engagement metrics such as activation counts, replay events, or time spent on the guided information panel to accurately reflect genuine second user behavior. Further, the autoplay orchestration module 220 is configured to track goals of the first user. The goals comprise get a quote, book time, see licenses etc. Further, based on the goals, the autoplay orchestration module 220 may ask follow up questions from the first user or the second user, or illuminate icons.

In some embodiments, the at least one processor 200 executing the one or more computer readable instructions stored in the memory is further configured to record, via a contact update propagation module 222 communicatively coupled to the at least one processor 200, save or share events generated by the second user. These recorded events form part of the engagement metrics that are determined from interactions with the guided information panel, such as activation counts, share events, or save events. By capturing these events, the contact update propagation module 222 enables the media introduction and curated information delivery system 100 to strengthen the system-level effectiveness measure associated with the displayed guided information panel.

In some embodiments, the contact update propagation module 222 is further configured to maintain a registry of the second user and to transmit update notifications with granular change-sets and deep-links to relevant sections of the guided information panel. Such notifications allow the second user to directly access sections including services, portfolio, events, blogs, or property listings without sequential navigation. By supporting precise change-sets and direct links, the system enhances responsiveness of the scrolling navigation interface while reinforcing engagement through replay events or time spent on relevant sections. The registry of the second user ensures continuity of preferences across multiple sessions, permitting consistent customization of the first dynamic media presentation and the second dynamic media presentation based on observed behavior of the second user.

In some embodiments, the at least one processor 200 executing the one or more computer readable instructions stored in the memory is further configured to import and transform, via an asset ingestion module 224 communicatively coupled to the at least one processor 200, third-party creative assets into sequenced presentations consumable by the media sequencing engine 206. The asset ingestion module 224 may adapt such assets so that branded visual asset motion graphics, visual effects, synchronized audio, or text can be incorporated into the first dynamic media presentation, while logos, taglines, animated marks, static images, or video clips of the first user can be aligned with the second dynamic media presentation. This process allows externally sourced content to remain synchronized with the transitions defined by the media sequencing engine 206.

In some embodiments, the asset ingestion module 224 further enables transformed assets to be integrated into the guided information panel displayed through the scrolling navigation interface. By aligning imported content with sections such as press/media, events, blogs, property listings, or public cards directory, the media introduction and curated information delivery system 100 ensures that filtered factual data of the first user remains enriched with relevant supporting materials. Synchronization of these sequenced presentations with the second dynamic media presentation preserves the continuity of contextual information, while maintaining accuracy of engagement metrics such as click-through rates, share events, or replay events that are monitored from the second user's interactions.

In some embodiments, the media introduction and curated information delivery system 100 further comprises a team management dashboard configured to define schema templates and propagate global updates across the digital contact card of the first user. By defining schema templates, the team management dashboard ensures that structural elements of the digital contact card, such as sections, layout, and contextual information, remain consistent across all instances. Propagation of global updates ensures that any modifications applied to the digital contact card of the first user are uniformly reflected in all synchronized presentations and guided information panels.

In some embodiments, the team management dashboard is also configured to support role-based access, single sign-on, and lifecycle synchronization. Role-based access allows differentiated levels of control over updates and schema template management, while single sign-on simplifies access for authorized users across sessions. Lifecycle synchronization ensures that changes to the digital contact card of the first user remain aligned with updates to the first dynamic media presentation, the second dynamic media presentation, and the guided information panel, preserving consistency of factual data delivered to the second user.

It will be apparent to one skilled in the art that the above-mentioned components of the server 102 have been provided only for illustration purposes, without departing from the scope of the disclosure.

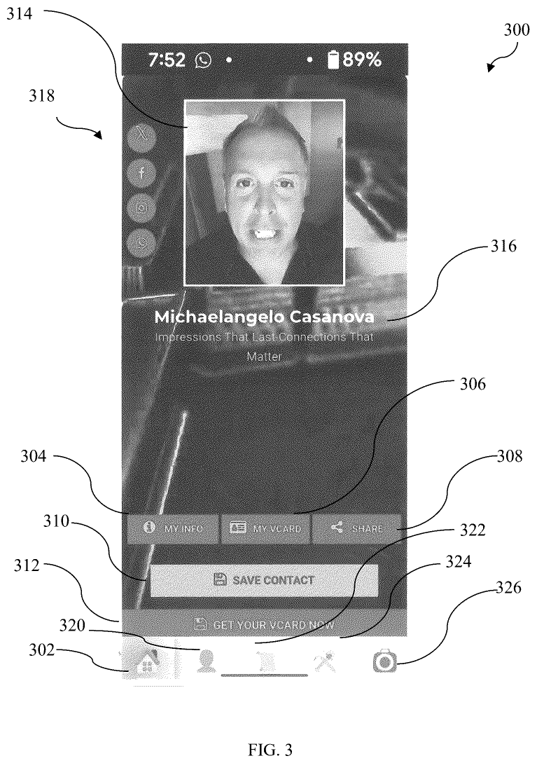

FIG. 3 illustrates an exemplary user interface view of a scrolling panel 300 showing a “Home” module icon 302 in an active illuminated state with associated action buttons according to an embodiment of the present disclosure.

In some embodiments, the scrolling panel 300 provides a structured arrangement of selectable modules and interactive elements configured to enable intuitive navigation by a second user. In the illustrated embodiment, the “Home” module icon 302 is shown in an active illuminated state. The illumination of the “Home” module icon 302 is dynamically triggered by the scrolling navigation interface module 210 to visually emphasize the currently active selection. Such illumination may include highlighting, outlining, or animating the “Home” module icon 302 to indicate that the second user is presently interacting with, or situated within, the “Home” section of the guided information panel.

Associated with the illuminated “Home” module icon 302 are a plurality of action buttons configured to provide quick access to contextual functions. For example, action buttons such as a “My Info” button 304, a “My vCard” button 306, and a “Share” button 308 are displayed within the scrolling panel 300. These action buttons are communicatively coupled with the memory 202 and executed by the at least one processor 200, enabling the second user to retrieve factual data of the first user, access digital business card details, or share curated content respectively. Additionally, a “Save Contact” button 310 and a “Get Your vCard Now” button 312 are provided to facilitate streamlined data exchange, further enhancing interactivity and engagement metrics. The arrangement of the scrolling panel 300, combined with the illuminated “Home” module icon 302, exemplifies how the media introduction and curated information delivery system 100 synchronizes filtered factual data with dynamic visual cues to create a responsive and personalized guided information panel.

In some embodiments, the My Info” button 304 provides structured factual data of the first user, filtered and synchronized with the guided information panel, enabling the second user to quickly access background details. Further, the “My vCard” button 306 to play dynamic intro video of the first user and is configured to deliver a digital contact card containing structured contact fields of the first user, retrievable and savable to the device of the second user. Further, the “Share” button 308 is configured to allow the second user to share the guided information panel or dynamic media presentation externally through supported platforms. Further, the ‘Save Contact” button 310 is configured to enable direct saving of the first user's factual contact data to the local address book of the second user's device.

In some embodiments, the “Get Your vCard Now” button 312 is configured to provide an entry point for the second user to create or request their own vCard within the media introduction and curated information delivery system 100, thereby extending interactive participation. Further, prominently positioned in the central upper region, an image 314 corresponds to image of the first user retrieved and curated by the information curation module 208, and is configured to establish immediate recognition for the second user. Further, a name and tagline 316 of the first user is shown directly below the image 314, the name provides factual identification while the tagline or mission phrase conveys curated contextual information.

Further, the scrolling panel 300 comprises social media account links 318 (left side vertical bar) comprising selectable icons such as professional networks, social platforms, or messaging services. Each icon of the social media account links 318 is linked to external digital presence data of the first user, configured for activation when selected by the second user. Further, the scrolling panel comprises an “About me” button 320. In some embodiments, the “About me” button 320 is configured to present personal background information about the vCard holder i.e. the first user, accompanied by an image, designed to humanize and build trust with the second user. Further, a “Mission statement” button 322 display a mission of the first user's company. Further, a “Services” button 324 lists services or products offered by the company. Further, a “Portfolio” button 326 is configured to provide gallery of images or media showcasing the company's work.

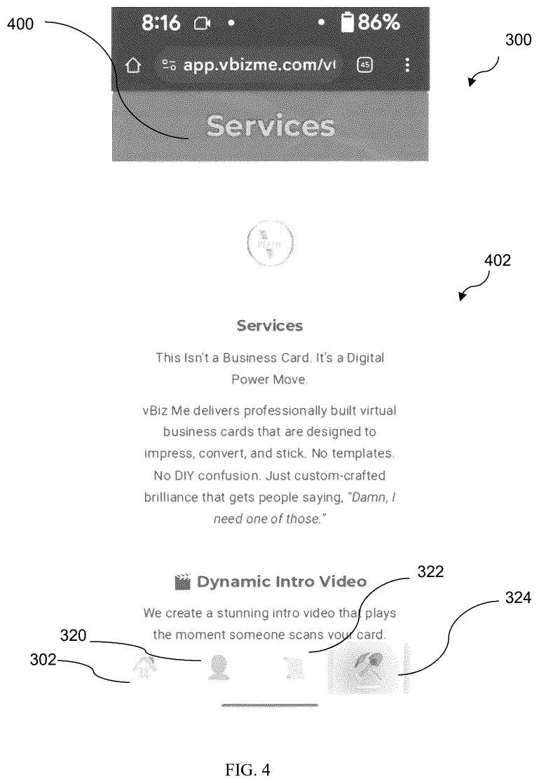

FIG. 4 illustrates an exemplary user interface view of the scrolling panel 300 showing the “Services” button 324 in an active illuminated state with associated action buttons according to an embodiment of the present disclosure.

As described earlier, the “Services” button 324 is configured to display the lists of services or products offered by the company. In the illustrated embodiment, the “Services” button 324 is shown in an active illuminated state. The illumination of the “Services” button 324 is dynamically triggered by the scrolling navigation interface module 210 to visually emphasize the currently active selection. Such illumination may include highlighting, outlining, or animating the “Services” button 324 to indicate that the second user is presently interacting with, or situated within, the “Services” button 324 of the guided information panel. Further, upon clicking the “Services” button 324, a services panel 400 is configured to display a text representing in an interesting manner a brief summary of the services provided by the company as shown by an arrow 402.

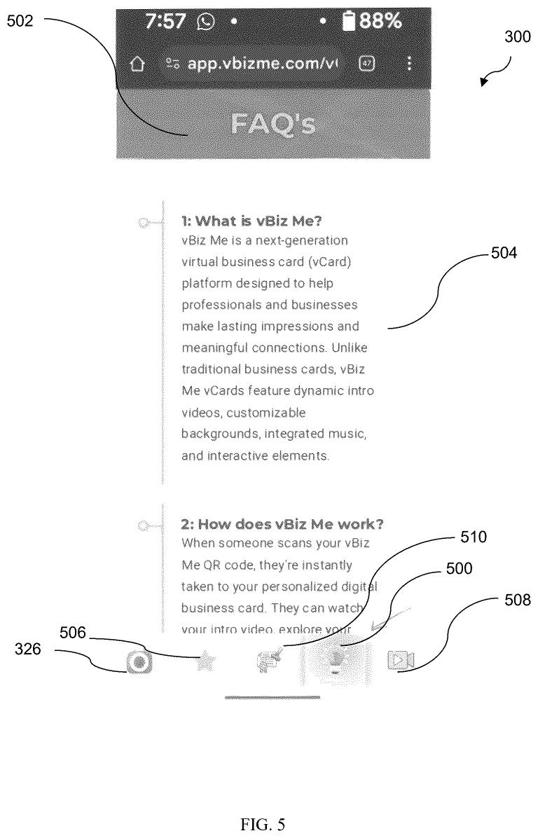

FIG. 5 illustrates an exemplary user interface view of the scrolling panel 300 showing “FAQs” button 500 in an active illuminated state with associated action buttons according to an embodiment of the present disclosure.

In some embodiments, the “FAQs” button 500 is configured to display answers to common customer questions, reducing the need for direct contact. In the illustrated embodiment, the “FAQs” button 500 is shown in an active illuminated state. The illumination of the “FAQs” button 500 is dynamically triggered by the scrolling navigation interface module 210 to visually emphasize the currently active selection. Such illumination may include highlighting, outlining, or animating the “FAQs” button 500 to indicate that the second user is presently interacting with, or situated within, the “FAQs” button 500 of the guided information panel. Further, upon clicking the “FAQs” button 500, a FAQs panel 502 is configured to display some facts about the company as shown by an arrow 504.

Further, the scrolling panel 300 comprises a “Reviews” button 506 configured to display written testimonials or links to third-party review platforms. Further, a “Why Choose us” button 508 is configured to offer persuasive reasons and soft-close sales messaging to encourage selection of the company. Further, a “Certificate/License” button 510 is configured to display certificates and licensing credentials with optional embedded images or PDFs.

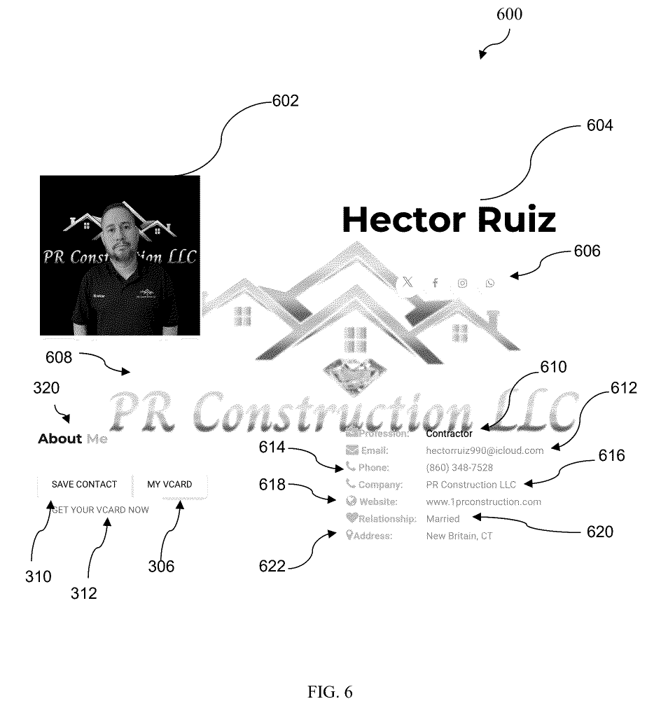

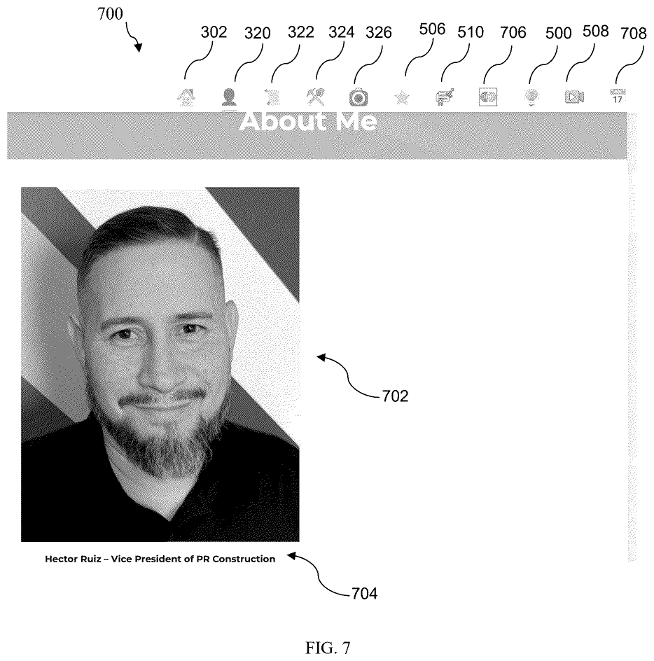

FIG. 6 illustrates an exemplary digital contact card 600 of the first user according to an embodiment of the present disclosure. FIG. 7 illustrates an “About Me” section 700 of the digital contact card 600 of the first user according to an embodiment of the present disclosure.

The digital contact card 600 includes an image 602 of the first user that is configured to serve as a visual factual identifier for recognition. The name 604 of the first user is displayed and configured to provide primary factual identification synchronized with the curated guided information panel. A plurality of social media icons 606 are provided and configured to link to external social media accounts or communication channels associated with the first user. A background branding or logo 608 is further configured to reinforce the professional or organizational association of the first user. The digital contact card 600 further includes an “About Me” button 320 configured to indicate an active section of the scrolling navigation interface and to guide the second user to contextual personal and professional data.

Additionally, one or more action buttons are provided, including the “Save Contact” button 310 configured to store structured factual data into the second user's device contact directory. Further, the “My vCard” button 306 is configured to deliver the full digital vCard containing structured fields of the first user, and a “Get Your vCard Now” button 312 configured to enable the second user to generate or request their own vCard. The digital contact card 600 also includes structured factual data fields such as a profession field 610 configured to identify the professional designation of the first user, an email field 612 configured to provide a machine-readable email address, a phone field 614 configured to provide a telecommunication number, a company field 616 configured to identify the organizational affiliation, a website field 618 configured to provide access to a professional or personal website, a relationship field 620 configured to indicate relationship status, and an address field 622 configured to provide geographic location information of the first user.

As illustrated in FIG. 7, the “About Me” section 700 is configured to display contextual factual data of the first user within a dedicated panel of the scrolling navigation interface. The section includes a photographic image 702 of the first user that is configured to serve as a visual identifier synchronized with the guided information panel. A textual description 704 associated with the first user, such as the designation “Vice President of PR Construction,” is further configured to provide professional and contextual relevance to the second user. A navigation header with a plurality of selectable module icons is displayed at the top of the interface, wherein the “About Me” button 320 is highlighted to indicate that the second user is actively viewing the corresponding section. The “About Me” button 320 thereby enables the presentation of structured personal and professional information in a visually distinct and user-navigable format.

Further, selectable module icons also comprise a DCP button 706. The DCP button 706 is configured to provide a hyperlink to verify contractor licensing through the department of customer protection. Further, a “better business bureau (BBB)” button is configured to provide a hyperlink to the company's BBB profile. Further, a “2-D Explainer Video” button is configured to display a short animation video describing the company's services and products. Further, a “Press media” button displays releases, news mentions, or embedded media videos via URL link image. Further, a “Event” button is configured to list upcoming or past events relevant to the companies.

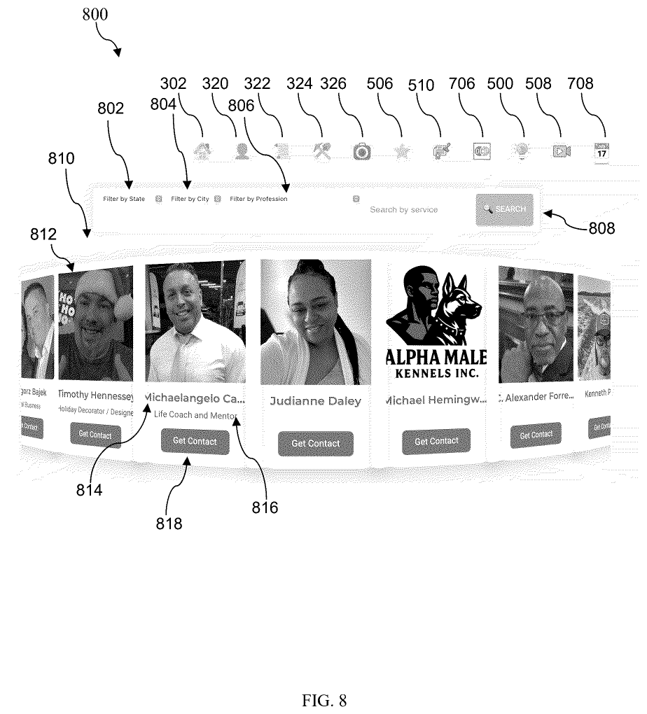

Further, a “Blog” button is configured to display articles, thought leadership pieces, or updates written by the digital contact card 600. Further, a “Clients” button is configured to lists notable clients or projects to build credibility. Further, a “Resume” button is configured to display the digital contact card holder's professional resume or CV. Further, a “Property listing” button is configured for real estate professionals and provides URL links to active property listings. Further, a” Menu” button is configured for restaurants, provides menu in PDF or URL format. Further, a “Calendar” button 708 is configured to display real-time availability, enabling potential clients to view open time slots. Further, a “Public cards” button is configured to display a searchable and filtered directory of other users, filtered by occupation and location, as shown in FIG. 8.

FIG. 8 illustrates the a searchable and filtered directory 800 of other users according to an embodiment of the present disclosure.

The searchable and filtered directory 800 includes one or more filtering options such as “Filter by State,” 802, “Filter by City,” 804, and “Filter by Profession,” 806, along with a search bar 808 configured to enable the second user to locate desired user profiles based on service-related queries. The searchable and filtered directory 800 displays user profiles in a card-style layout 810 arranged in a series, where each card contains at least an image or logo 812 of the user, the name of the user, illustrated by an arrow 814, a professional designation 816, and an action button 818 such as “Get Contact.” The card-style layout 810 are presented in a horizontally scrollable carousel view such that the second user may navigate the series of cards by moving left-to-right or right-to-left. Each card is configured with a floating or sliding animation during navigation, thereby creating a smooth transition effect that enhances the interactive user experience and visual appeal of the directory interface.

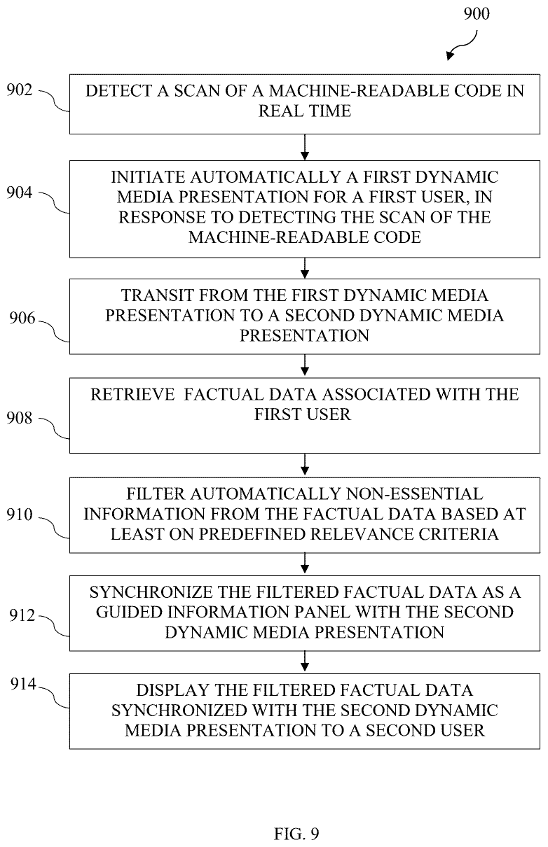

FIG. 9 illustrates a flowchart showing a method 900 according to an embodiment of the present disclosure.

At operation 902, the at least one processor 200 detects, via the trigger event detection module 204 communicatively coupled to the at least one processor 200, the scan of a machine-readable code in real time. The trigger event detection module 204 may be communicatively coupled to the at least one processor 200 and adapted to detect, in real time, the scan of a machine-readable code such as a QR code, bar code, near-field communication (NFC) tag, or similar trigger input. In some embodiments, the trigger event detection module 204 may process input signals received from a sensor, camera, or scanning interface of the first user device 106, and relay the scan event to the at least one processor 200 for immediate recognition. The at least one processor 200, in coordination with the memory 202, may then validate the scan data, initiate a corresponding session, and log the trigger event for subsequent processing. This correlation of trigger event detection module 204, the at least one processor 200, and the memory 202 ensures both accurate detection and reliable initiation of downstream media presentation workflows.

At operation 904, the at least one processor 200 initiates, via a media sequencing engine 206 communicatively coupled to the at least one processor 200, automatically the first dynamic media presentation for the first user, in response to detecting the scan of the machine-readable code. In some embodiments, upon detecting the scan of the machine-readable code, the at least one processor 200, executing computer-readable instructions stored in the memory 202, may further be configured to operate in conjunction with the media sequencing engine 206. The media sequencing engine may be communicatively coupled to the at least one processor 200 and designed to automatically initiate the first dynamic media presentation for the first user in direct response to the detected scan event. The media sequencing engine 206 may retrieve one or more pre-stored media assets from the memory 202 or from an associated data repository and arrange in a predefined sequence. These one or more pre-stored assets may include, for example, branded visual asset motion graphics, synchronized audio tracks, visual effects, or stylized text elements.

The at least one processor 200 may execute the sequencing logic of the media sequencing engine 206 to ensure that the first dynamic media presentation begins seamlessly and without requiring manual intervention by the first user. In some embodiments, by coordinating the sequencing operations with the at least one processor 200 and the memory 202, the media sequencing engine 206 provides a controlled and automated introduction that immediately captures attention following the scan event. This ensures that the transition from the trigger input to the display of branded media is rapid, consistent, and emotionally engaging, thereby reducing latency and increasing the overall effectiveness of the media introduction and curated information delivery system 100.

At operation 906, the at least one processor 200 transits, via the media sequencing engine 206, from the first dynamic media presentation to a second dynamic media presentation. In some embodiments, the at least one processor 200, executing computer-readable instructions stored in the memory 202, may further be configured to operate in conjunction with the media sequencing engine 206 to manage a transition from the first dynamic media presentation to the second dynamic media presentation. The transition may occur automatically after completion of the first presentation or upon detection of a predefined trigger condition, thereby ensuring continuity in the delivery of information to the second user. The term “predefined trigger condition” refers to one or more preset events or parameters, such as time lapse, user interaction, or system signal, that when detected cause automatic transition between media presentations. The media sequencing engine 206 may direct the at least one processor 200 to retrieve from the memory 202, or from an external repository, one or more assets that compose the second dynamic media presentation.

In some embodiments, the second dynamic media presentation may include at least one of a company logo, tagline, animated mark, a static image of the first user with contextual information, or a video clip featuring the first user. The media sequencing engine 206 may further coordinate timing, order, and blending of these one or more assets to achieve a smooth and contextually relevant transition between the first dynamic media presentation and the second dynamic media presentation. By leveraging the processing power of the at least one processor 200 and the structured asset storage within the memory 202, the media sequencing engine 206 ensures that the transition is executed without interruption or delay. This transition enhances the emotional engagement initiated by the first dynamic media presentation while introducing curated factual elements in the second dynamic media presentation, thereby aligning the sequence with the objectives of the media introduction and curated information delivery system 100.

At operation 908, the at least one processor 200 retrieves, via the information curation module 208 communicatively coupled to the at least one processor 200, factual data associated with the first user. In some embodiments, the at least one processor 200, in conjunction with the memory 202, may be configured to retrieve, via an information curation module 208 communicatively coupled to the at least one processor 200, the factual data associated with the first user. in some embodiments, the information curation module 208 may be configured to access one or more databases, local repositories, or remote storage systems where such factual data is maintained. The factual data may include, for example, professional details, business identifiers, portfolio items, credentials, or other verified information associated with the first user. By coordinating with the at least one processor 200 and memory 202, the information curation module 208 ensures that the factual data is retrieved in real time, enabling immediate integration into the ongoing dynamic media presentation sequence.

At operation 910, the at least one processor 200 filters, via the information curation module 208, automatically non-essential information from the factual data, based at least on predefined relevance criteria. In some embodiments, the at least one processor 200, in conjunction with the memory 202, may be configured to filter, via the information curation module 208 communicatively coupled to the at least one processor 200, non-essential information from the retrieved factual data, based at least on predefined relevance criteria. The filtering process may selectively eliminate redundant, outdated, or less pertinent information, thereby retaining only factual content that carries immediate value for presentation. The predefined relevance criteria may include contextual importance, recency, or user-defined preferences, ensuring that the filtered factual data is concise and meaningful for display.

At operation 912, the at least one processor 200 synchronize the filtered factual data as the guided information panel with the second dynamic media presentation. In some embodiments, the filtered factual data may be synchronized by the at least one processor 200 with the second dynamic media presentation, thereby forming a guided information panel. The synchronization process may align the factual data with the visual or interactive sequence of the second dynamic media presentation, creating a cohesive and structured flow of information. The guided information panel may be composed of one or more sections configured to illuminate, outline, enhance, or animate in response to active selection by the second user, and may include sections such as home, about me, mission statement, services, portfolio, reviews, why choose us, certificates/licenses, Dept. of Consumer Protection license look-up (DCP) link, frequently asked questions, 2D explainer video, press/media, events, blogs, clients, resume, property listings, menu, calendar, and public cards directory.

At operation 914, the at least one processor 200 displays, via the scrolling navigation interface module 210 communicatively coupled to the at least one processor, the filtered factual data synchronized with the second dynamic media presentation to a second user. In some embodiments, the at least one processor 200 may further be configured to display, via a scrolling navigation interface module 210 communicatively coupled to the at least one processor 200, the filtered factual data synchronized with the second dynamic media presentation to the second user. The scrolling navigation interface module 210 may present the guided information panel in an interactive manner, allowing the second user to navigate through the various sections with minimal effort. The filtered factual data synchronized with the second dynamic media presentation enhances accessibility and user engagement by ensuring that high-value factual data remains synchronized with the second dynamic media presentation, while maintaining an intuitive and visually engaging interface.

In some embodiments, the at least one processor 200 executing the one or more computer readable instructions stored in the memory is further configured to render, via an interactive agent module 218 communicatively coupled to the at least one processor 200, an avatar synchronized with the second dynamic media presentation. The synchronization allows the avatar to appear in alignment with transitions of company logos, taglines, animated marks, static images, or video clips of the first user, such that the avatar remains contextually bound to the second dynamic media presentation. By doing so, the interactive agent module 210 ensures that the filtered factual data, already synchronized with the second dynamic media presentation, may be delivered in a more engaging form to the second user.

In some embodiments, the interactive agent module 218 further enables the avatar to accept a natural-language input from the second user, and based on such input, execute context-specific actions including at least save contact, share, book meeting, or get a digital contact card. These actions may be reflected within the guided information panel that is displayed through the scrolling navigation interface. For instance, a save contact or share command may correspond to a monitored interaction that contributes toward engagement metrics, while a book meeting or get a digital contact card action may extend the second user's interaction time with the guided information panel. In this manner, the avatar operates as a responsive element of the second dynamic media presentation, while remaining directly linked to the behavior and preferences of the second user. In some embodiments, the media sequencing engine 206 further synchronizes timing of an entrance of the avatar with branded media.

In some embodiments, the at least one processor 200 executing the one or more computer readable instructions stored in the memory is configured to detect, via an autoplay orchestration module 220 communicatively coupled to the at least one processor 200, autoplay restrictions that may otherwise prevent immediate initiation of synchronized audio in the first dynamic media presentation or the second dynamic media presentation. The autoplay orchestration module 220 is further configured to pre-buffer media so that transitions between branded visual asset motion graphics, visual effects, synchronized audio, or contextual information of the first user occur without perceptible delay. By performing these operations in advance, the media introduction and curated information delivery system 100 maintains continuity of sequencing between the first dynamic media presentation and the second dynamic media presentation.

In some embodiments, the autoplay orchestration module 220 is also configured to bind a compliant micro-gesture to unlock audio contexts and to insert a silent pre-roll to enable audible playback during both the first dynamic media presentation and the second dynamic media presentation. Binding the compliant micro-gesture ensures that the second user may unlock synchronized audio without disruptive manual steps, while the silent pre-roll establishes an audio context that complies with playback environments. Together, binding the compliant micro-gesture enhance responsiveness of the scrolling navigation interface and preserve the alignment of filtered factual data synchronized with the second dynamic media presentation, allowing engagement metrics such as activation counts, replay events, or time spent on the guided information panel to accurately reflect genuine second user behavior.

In some embodiments, the at least one processor 200 executing the one or more computer readable instructions stored in the memory is further configured to record, via a contact update propagation module 222 communicatively coupled to the at least one processor 200, save or share events generated by the second user. These recorded events form part of the engagement metrics that are determined from interactions with the guided information panel, such as activation counts, share events, or save events. By capturing these events, the contact update propagation module 222 enables the media introduction and curated information delivery system 100 to strengthen the system-level effectiveness measure associated with the displayed guided information panel.

In some embodiments, the contact update propagation module 222 is further configured to maintain a registry of the second user and to transmit update notifications with granular change-sets and deep-links to relevant sections of the guided information panel. Such notifications allow the second user to directly access sections including services, portfolio, events, blogs, or property listings without sequential navigation. By supporting precise change-sets and direct links, the system enhances responsiveness of the scrolling navigation interface while reinforcing engagement through replay events or time spent on relevant sections. The registry of the second user ensures continuity of preferences across multiple sessions, permitting consistent customization of the first dynamic media presentation and the second dynamic media presentation based on observed behavior of the second user.

In some embodiments, the at least one processor 200 executing the one or more computer readable instructions stored in the memory is further configured to import and transform, via an asset ingestion module 224 communicatively coupled to the at least one processor 200, third-party creative assets into sequenced presentations consumable by the media sequencing engine 206. The asset ingestion module 224 may adapt such assets so that branded visual asset motion graphics, visual effects, synchronized audio, or text can be incorporated into the first dynamic media presentation, while logos, taglines, animated marks, static images, or video clips of the first user can be aligned with the second dynamic media presentation. This process allows externally sourced content to remain synchronized with the transitions defined by the media sequencing engine 206.

In some embodiments, the at least one processor 200, in conjunction with the memory 202, may be configured to monitor, via an engagement tracking module 212 communicatively coupled to the at least one processor 200, one or more interactions of the second user on the displayed guided information panel. The interactions may include navigation through sections of the panel, selections of links, or activations of embedded media. By continuously monitoring such actions, the engagement tracking module 212 may collect detailed activity logs that reflect how the second user interacts with the synchronized content.

In some embodiments, the engagement tracking module 212 may further be configured to determine one or more engagement metrics based at least on the monitored one or more interactions to assess the behavior and preferences of the second user. The one or more engagement metrics may correspond to an effectiveness of the displayed guided information panel to the second user, wherein the effectiveness is defined as a measure of the one or more engagement metrics. The engagement metrics may comprise, for example, activation counts, time spent on the guided information panel, click-through rates on calls-to-action, share events, save events, and replay events. These one or more engagement metrics may enable the at least one processor 200 to identify patterns in user behavior, gauge the level of interest in particular sections, and refine the structure and presentation of the guided information panels to better match the behavior and preferences.

In some embodiments, the at least one processor 200, in conjunction with the memory 202, may be configured to customize, via the customization module 214 communicatively coupled to the at least one processor 200, the visual and structural aspects of the first dynamic media presentation and the second dynamic media presentation. The customization may be performed automatically in real time, based at least on the determined behavior and preferences of the second user as identified by the engagement tracking module. The customization module 214 may dynamically alter color schemes, logos, and layout templates to enhance the visual appeal and relevance of the media presentations. For example, if the second user demonstrates repeated interaction with certain brand-related elements, the at least one processor 200 may emphasize such elements by applying a consistent color scheme, enlarging the associated logo, or adjusting the layout to highlight the preferred content. By adapting the presentations in this manner, the at least one processor 200 may deliver a personalized and contextually relevant media experience that resonates with the second user and increases overall engagement.

In some embodiments, the at least one processor 200, in conjunction with the memory 202, may be configured to train, via the machine learning (ML) module 216 communicatively coupled to the at least one processor 200, one or more predictive models. The training may be performed based at least on the determined behavior and preferences of the second user, as obtained through the engagement tracking module 212. By analyzing recurring interaction patterns and contextual engagement data, the ML module 216 may enable the predictive models to evolve over time, thereby refining the system's ability to anticipate user needs and responses.

In accordance with the present disclosure, a searchable and filtered directory system enables the second user to efficiently discover and access other user profiles through multiple filtering options such as state, city, and profession, as well as a keyword-based service search. User profiles are presented in a card-style layout arranged in a horizontal series, each card comprising at least an image or logo, user name, professional designation, and a selectable action button configured to initiate contact retrieval. Unlike conventional static directories that display tabular lists or text-based entries, the disclosed interface employs a horizontally scrollable carousel mechanism wherein the series of cards may be navigated in either left or right direction. Each card is further configured to float or slide with animation during navigation, thereby producing a dynamic transition effect that enhances usability, maintains user engagement, and improves overall visual experience. This architecture allows rapid comparison of multiple user profiles within a visually intuitive environment while supporting efficient filtering and targeted discovery.

A non-transitory computer-readable medium storing instructions that, when executed by at least one processor, cause the at least one processor to detect, via a trigger event detection module communicatively coupled to the at least one processor, a scan of a machine-readable code being associated with a first user in real time; initiate, via a media sequencing engine communicatively coupled to the at least one processor, automatically a first dynamic media presentation for the first user, in response to detecting the scan of the machine-readable code; transit, via the media sequencing engine, from the first dynamic media presentation to a second dynamic media presentation; retrieve, via an information curation module communicatively coupled to the at least one processor, factual data associated with the first user; filter, via the information curation module, automatically non-essential information from the factual data based at least on a predefined relevance criteria; synchronize the filtered factual data as a guided information panel with the second dynamic media presentation; and display, via a scrolling navigation interface module communicatively coupled to the at least one processor, the filtered factual data synchronized with the second dynamic media presentation to a second user.

Conventional systems for digital introductions and information delivery typically rely on static bios or static profile pages that provide only text-based details without contextual synchronization. Such static approaches fail to capture dynamic interactions, do not adapt presentations in real time, and are unable to filter factual data according to relevance. As a result, second users are presented with large amounts of undifferentiated information, leading to higher latency in retrieving key details, reduced engagement, and ineffective personalization. In contrast, the present disclosure provides a media introduction and curated information delivery system that dynamically sequences media, filters factual data, and synchronizes the filtered data with one or more dynamic media presentations. By leveraging engagement metrics and predictive models, the system adapts in real time to the behavior and preferences of the second user. This configuration improves computer functionality by enabling more efficient bandwidth allocation, reduced latency during transitions, and enhanced responsiveness of the scrolling navigation interface. The system also incorporates data privacy controls and opt-in mechanisms, thereby ensuring protection of factual data while still delivering a curated and interactive presentation experience.

These improvements enable the at least one processor to operate in a technically superior manner compared to conventional systems. Specifically, the coordinated rendering of dynamic media with filtered factual data enhances synchronization accuracy, reduces processing overhead associated with unnecessary information delivery, and optimizes the sequencing engine for real-time responsiveness. The system-level effectiveness measure derived from monitored interactions provides an additional technical advantage, as it allows continuous refinement of filtering, synchronization, and customization processes, thereby directly improving the functioning of the underlying computer system. In some embodiments, the system may require a stored consent token before parameters relating to face or voice cloning are accessed, thereby ensuring that such actions are only executed with explicit authorization. The system may further apply moderation filters to suppress outputs that do not comply with permitted usage, maintaining the integrity of the media presentation. Additionally, logs may include policy flags that record compliance status, enabling reliable tracking of events associated with the guided information panel and the dynamic media presentations.

While there is shown and described herein certain specific structures embodying various embodiments of the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims. For example, external plates, such as the pendant front and back plates may be connected to internal securing plates (e.g., front plate and back plate caps) in various ways not explicitly described. Additionally, elements as shown in the drawings, though not specifically mentioned in the present disclosure still comprise elements of the invention.

### LIST OF ELEMENTS

100—media introduction and curated information delivery system
102—SERVER
104—NETWORK
106—FIRST USER DEVICE
108—SECOND USER DEVICE
200—AT LEAST ONE PROCESOR
202—MEMORY
204—TRIGGER EVENT DETECTION MODULE
206—MEDIA SEQUENCING ENGINE
208—INFORMATION CURATION MODULE
210—SCROLLING NAVIGATION INTERFACE MODULE
212—ENGAGEMENT TRACKING MODULE
214—CUSTOMIZATION MODULE
216—MACHINE LEARNING (ML) MODULE
218—INTERACTIVE AGENT MODULE
220—AUTOPLAY ORCHESTRATION MODULE
222—CONTACT UPDATE PROPAGATION MODULE
224—ASSET INGESTION MODULE
300—SCROLLING PANEL
302—“HOME” MODULE ICON
304—“MY INFO” BUTTON
306—“MY VCARD” BUTTON
308—“SHARE” BUTTON
310—“SAVE CONTACT” BUTTON
312—“GET YOUR VCARD NOW” BUTTON
314—IMAGE
316—NAME AND TAGLINE
318—SOCIAL MEDIA ACCOUNT LINKS
320—“ABOUT ME” BUTTON
322—“MISSION STATEMENT” BUTTON
324—“SERVICES” BUTTON
326—“PORTFOLIO” BUTTON
400—“SERVICES” PANEL
402—ARROW
500—“FAQS” BUTTON
502—“FAQS” PANEL
504—ARROW
506—“REVIEWES” BUTTON
508—“WHY CHOOSE US” BUTTON
510—“CERTFICATE/LICENSE” BUTTON
600—DIGITAL CONTACT CARD
602—IMAGE
604—NAME
606—SOCIAL MEDIA ICONS
608—BRANDING OR LOGO
610—PROFESSION FIELD
612—EMAIL FIELD
614—PHONE FIELD
616—COMPANY FILED
618—WEBSITE FIELD
620—RELATIONSHIP FIELD
622—ADDRESS FIELD
700—“ABOUT ME” SECTION
702—PHOTOGRAPHIC IMAGE
704—TEXTUAL DESCRIPTION
706—DCP BUTTON
708—“CALENDAR” BUTTON
800—FILTERED DIRECTOR
802—FILTER BY STATE
804—FILTER BY CITY
806—FILTER BY PROFESSION
808—SEARCH BAR
810—CARD-STYLE LAYOUT
812—IMAGE OR LOGO
814—ARROW
816—PROFESSIONAL DESIGNATION
818—ACTION BUTTON
900—METHOD
902—STEP
904—STEP
906—STEP
908—STEP
910—STEP
912—STEP
914—STEP

What is claimed is:

1. A media introduction and curated information delivery system comprising:
a memory having one or more computer readable instructions; and
at least one processor communicatively coupled with the memory, wherein the at least one processor executing the one or more computer readable instructions stored in the memory is configured to:
detect, via a trigger event detection module communicatively coupled to the at least one processor, a scan of a machine-readable code being associated with a first user in real time;
initiate, via a media sequencing engine communicatively coupled to the at least one processor, automatically a first dynamic media presentation for the first user, in response to detecting the scan of the machine-readable code;
transit, via the media sequencing engine, from the first dynamic media presentation to a second dynamic media presentation;
retrieve, via an information curation module communicatively coupled to the at least one processor, factual data associated with the first user;
filter, via the information curation module, automatically non-essential information from the factual data based at least on a predefined relevance criteria;
synchronize the filtered factual data as a guided information panel with the second dynamic media presentation; and
display, via a scrolling navigation interface module communicatively coupled to the at least one processor, the filtered factual data synchronized with the second dynamic media presentation to a second user.

2. The media introduction and curated information delivery system of claim 1, wherein the first dynamic media presentation comprises at least one of branded visual asset motion graphics, visual effects, synchronized audio, or text, and wherein the second dynamic media presentation comprises at least one of company logo, tagline, animated mark, a static image of the first user with contextual information, or a video clip featuring the first user.

3. The media introduction and curated information delivery system of claim 1, wherein the at least one processor executing the one or more computer readable instructions stored in the memory is configured to:
monitor, via an engagement tracking module communicatively coupled to the at least one processor, one or more interactions of the second user on the displayed guided information panel; and
determine, via the engagement tracking module, one or more engagement metrics based at least on the monitored one or more interactions to determine behavior and preferences of the second user, wherein the one or more engagement metrics correspond to a system-level effectiveness measure of the displayed guided information panel to the second user, and wherein the one or more engagement metrics comprises at least one of activation counts, time spent on the guided information panel, click-through rates on calls-to-action, share events, save events, or replay events, wherein the system-level effectiveness measure being used to optimize bandwidth allocation, preloading of content, or user interface responsiveness.

4. The media introduction and curated information delivery system of claim 3, wherein the at least one processor executing the one or more computer readable instructions stored in the memory is configured to customize, via a customization module communicatively coupled to the at least one processor, automatically color schemes, logos, and layout templates of the first dynamic media presentation and the second dynamic media presentation in real time based at least on the determined behavior and preferences of the second user.

5. The media introduction and curated information delivery system of claim 1, wherein the guided information panel comprises one or more sections configured to illuminate, outline, enhance, or animate to indicate active selection of the one or more sections by the second user, and wherein the one or more sections comprises at least one of home, about me, mission statement, services, portfolio, reviews, why choose us, certificates/licenses, Dept. of Consumer Protection license look-up (DCP) link, frequently asked questions, 2D explainer video, press/media, events, blogs, clients, resume, property listings, menu, calendar, and public cards directory.

6. The media introduction and curated information delivery system of claim 1, wherein the at least one processor is configured to protect the factual data of the first user, using data privacy controls and opt-in mechanisms.

7. The media introduction and curated information delivery system of claim 3, wherein the at least one processor executing the one or more computer readable instructions stored in the memory is configured to train, via a machine learning module communicatively coupled to the at least one processor, one or more predictive models based at least on the determined behavior and preferences of the second user, the one or more predictive models being further configured to dynamically improve filtering of the factual data, synchronizing the filtered factual data, and customizing the first dynamic media presentation and the second dynamic media presentation.

8. The media introduction and curated information delivery system of claim 1, wherein the at least one processor executing the one or more computer readable instructions stored in the memory is configured to:
render, via an interactive agent module communicatively coupled to the at least one processor, an avatar synchronized with the second dynamic media presentation, the avatar is configured to accept a natural-language input from the second user and based on which configured to execute context-specific actions including at least save contact, share, book meeting, or get a digital contact card;
detect, via an autoplay orchestration module communicatively coupled to the at least one processor, autoplay restrictions, pre-buffer media, bind a compliant micro-gesture to unlock audio contexts, and insert a silent pre-roll to enable audible playback during the first dynamic media presentation and the second dynamic media presentation;
record, via a contact update propagation module communicatively coupled to the at least one processor, save or share events, maintain a registry of the second user, and transmit update notifications with granular change-sets and deep-links to relevant sections of the guided information panel; and
import and transform, via an asset ingestion module communicatively coupled to the at least one processor, third-party creative assets into sequenced presentations consumable by the media sequencing engine.

9. The media introduction and curated information delivery system of claim 1, further comprises a team management dashboard configured to define schema templates and propagate global updates across the digital contact card of the first user, supporting role-based access, single sign-on, and lifecycle synchronization.

10. The media introduction and curated information delivery system of claim 1, wherein the scrolling navigation interface module further comprises sponsored placements within one or more sections, the placements being selected and ordered using engagement metrics or predictive models.

11. A method comprising:
detecting, via at least one processor of a media introduction and curated information delivery system communicatively coupled with a memory and using a trigger event detection module communicatively coupled to the at least one processor, a scan of a machine-readable code being associated with a first user in real time;
initiating, via the at least one processor using a media sequencing engine communicatively coupled to the at least one processor, automatically a first dynamic media presentation for the first user, in response to detecting the scan of the machine-readable code;
transiting, via the at least one processor using the media sequencing engine, from the first dynamic media presentation to a second dynamic media presentation;
retrieving, via the at least one processor using an information curation module communicatively coupled to the at least one processor, factual data associated with the first user;
filtering, via the at least one processor using the information curation module, automatically non-essential information from the factual data, based at least on predefined relevance criteria;
synchronizing, via the at least one processor, the filtered factual data as a guided information panel with the second dynamic media presentation; and
displaying, via the at least one processor using a scrolling navigation interface module communicatively coupled to the at least one processor, the filtered factual data synchronized with the second dynamic media presentation to a second user.

12. The method of claim 11, wherein the first dynamic media presentation comprises at least one of branded visual asset motion graphics, visual effects, synchronized audio, or text wherein the second dynamic media presentation comprises at least one of company logo, tagline, animated mark, a static image of the first user with contextual information, or a video clip featuring the first user.

13. The method of claim 11 further comprising:
monitoring, via the at least one processor using an engagement tracking module communicatively coupled to the at least one processor, one or more interactions of the second user on the displayed guided information panel; and
determining, via the at least one processor using the engagement tracking module, one or more engagement metrics based at least on the monitored one or more interactions to determine behavior and preferences of the second user wherein the one or more engagement metrics correspond to a system-level effectiveness measure of the displayed guided information panel to the second user, and wherein the one or more engagement metrics comprises at least one of activation counts, time spent on the guided information panel, click-through rates on calls-to-action, share events, save events, or replay events, wherein the system-level effectiveness measure being used to optimize bandwidth allocation, preloading of content, or user interface responsiveness.

14. The method of claim 13 further comprising customizing, via the at least one processor using a customization module communicatively coupled to the at least one processor, automatically color schemes, logos, and layout templates of the first dynamic media presentation and the second dynamic media presentation in real time based at least on the determined behavior and preferences of the second user.

15. The method of claim 11, wherein the guided information panel comprises one or more sections configured to illuminate, outline enhance, or animate to indicate active selection of the one or more sections by the second user, and wherein the one or more sections comprises at least one of home, about me, mission statement, services, portfolio, reviews, why choose us, certificates/licenses, Dept. of Consumer Protection license look-up (DCP) link, frequently asked questions, 2D explainer video, press/media, events, blogs, clients, resume, property listings, menu, calendar, and public cards directory.

16. The method of claim 11 further comprising protecting, via the at least one processor, the factual data of the first user, using data privacy controls and opt-in mechanisms.

17. The method of claim 13 further comprising training, via the at least one processor using a machine learning module communicatively coupled to the at least one processor, one or more predictive models based at least on the determined behavior and preferences of the second user, the one or more predictive models being further configured to dynamically improve filtering of the factual data, synchronizing the filtered factual data, and customizing the first dynamic media presentation and the second dynamic media presentation.

18. The method of claim 11 further comprising:
rendering, via an interactive agent module communicatively coupled to the at least one processor, an avatar synchronized with the second dynamic media presentation, the avatar is configured to accept a natural-language input from the second user and based on which configured to execute context-specific actions including at least save contact, share, book meeting, or get a digital contact card;
detecting, via an autoplay orchestration module communicatively coupled to the at least one processor, autoplay restrictions, pre-buffer media, bind a compliant micro-gesture to unlock audio contexts, and insert a silent pre-roll to enable audible playback during the first dynamic media presentation and the second dynamic media presentation;
recording, via a contact update propagation module communicatively coupled to the at least one processor, save or share events, maintain a registry of the second user, and transmit update notifications with granular change-sets and deep-links to relevant sections of the guided information panel; and
importing and transforming, via an asset ingestion module communicatively coupled to the at least one processor, third-party creative assets into sequenced presentations consumable by the media sequencing engine.

19. The method of claim 11, the media introduction and curated information delivery system further comprises a team management dashboard configured to define schema templates and propagate global updates across the digital contact card of the first user, supporting role-based access, single sign-on, and lifecycle synchronization, and wherein the scrolling navigation interface module further comprises sponsored placements within one or more sections, the placements being selected and ordered using engagement metrics or predictive models.

20. A non-transitory computer-readable medium storing instructions that, when executed by at least one processor, cause the at least one processor to:
detect, via a trigger event detection module communicatively coupled to the at least one processor, a scan of a machine-readable code being associated with a first user in real time;
initiate, via a media sequencing engine communicatively coupled to the at least one processor, automatically a first dynamic media presentation for the first user, in response to detecting the scan of the machine-readable code;
transit, via the media sequencing engine, from the first dynamic media presentation to a second dynamic media presentation;
retrieve, via an information curation module communicatively coupled to the at least one processor, factual data associated with the first user;
filter, via the information curation module, automatically non-essential information from the factual data based at least on a predefined relevance criteria;
synchronize the filtered factual data as a guided information panel with the second dynamic media presentation; and
display, via a scrolling navigation interface module communicatively coupled to the at least one processor, the filtered factual data synchronized with the second dynamic media presentation to a second user.
